(19) United States
(12) Patent Application Publication
(10) Pub. No.: US 2024/0129128 A1
(43) Pub. Date: Apr. 18, 2024

(54) ENROLLING BIOMETRICS WITH MUTUAL TRUST THROUGH 3RD PARTY

(71) Applicant: FINGERPRINT CARDS ANACATUM IP AB, GÖTEBORG (SE)

(72) Inventor: Mats TUNELD, LUND (SE)

(73) Assignee: FINGERPRINT CARDS ANACATUM IP AB, GÖTEBORG (SE)

(21) Appl. No.: 18/277,620

(22) PCT Filed: Feb. 14, 2022
(86) PCT No.: PCT/SE2022/050155

§ 371 Date: Aug. 17, 2023

(30) Foreign Application Priority Data
Feb. 26, 2021 (SE) 2150206-7

(51) Int. Cl. H04L 9/32

(52) U.S. Cl. CPC H04L 9/3231; H04L 9/3247; H04L 9/3268

(57) ABSTRACT

The present disclosure relates to a method of an access point of enrolling biometric data of an individual and an access point performing the method. In an aspect, a method of an access point is provided of enrolling biometric data of an individual. The method comprises establishing a trusted communication channel with a user device of the individual, the trust being ensured by a trusted 3rd party and capturing the biometric data of the individual, wherein the biometric data is enrolled with the access point.

### TECHNICAL FIELD

The present disclosure relates to a method of an access point of enrolling biometric data of an individual and an access point performing the method.

### BACKGROUND

Authentication utilizing biometric data with access points providing e.g. building access control, point-of-sale services, vehicle operation or other services might not be trusted by a user, and the user may thus be reluctant to present her biometric data to such an access point. The biometric data may be derived from a captured image of iris, face, fingerprint, palmprint, etc., of the user, or even from a voice recording, etc.

Likewise, an access point or point of sale provider might not trust a user to enroll in their system. Typically, a user would not like to use an external biometric capture device and have biometric templates stored in a non-trusted external equipment.

### SUMMARY

An objective is to solve this problem and thus to provide an improved method of enrolling biometric data of an individual with an access point.

This objective is attained in a first aspect by a method of an access point of enrolling biometric data of an individual. The method comprises establishing a trusted communication channel with a user device of the individual, the trust being ensured by a trusted 3^{rd} party, and capturing the biometric data of the individual, wherein the biometric data is enrolled with the access point.

This objective is attained in a second aspect by an access point configured to enroll biometric data of an individual. The access point comprises a processing unit configured to establish a trusted communication channel with a user device of the individual, the trust being ensured by a trusted 3^{rd} party, and a biometric data sensor configured to capture the biometric data of the individual, wherein the biometric data is enrolled with the access point.

As previously mentioned, a user will typically not want to enroll his biometric data with a system he does not trust. Conversely, the system will not want to enroll a user that the system does not trust. This is resolved by establishing a trusted communication channel between an access point and a user device, which trust is being ensured by a trusted 3^{rd} party embodied for example by a certificate authority (CA) issuing a certificate to each of the access point and the user device.

Such certificate is commonly referred to as a digital certificate or a public key certificate and includes i.a. a public key being certified by the issuer, which allows the user device to set-up a secure channel, information identifying the user device that owns the public key and a digital signature of the public key created by the issuer of the certificate, which is used to verify authenticity of transmitted data in the sense that the access point is ensured that the data is sent from the user device.

Upon setting up a communication channel, the access point and the user device will exchange messages signed with the digital signatures included in the certificates, wherein the trust of the channel is ensured by the originally having issued the certificates being utilized to set up the trusted communication channel between the access point and the user device.

With the establishment of the trusted channel, the access point is advantageously allowed to enroll the biometric data of the user, e.g. using a camera to capture an image of the user's face.

In an embodiment, the establishing of the trusted communication channel comprises exchanging messages comprising a digital signature of certificates issued by the trusted 3^{rd} party to the access point and the user device of the individual.

In an embodiment, the establishing of the trusted communication channel comprises acquiring a notification from the trusted 3^{rd} party that the trusted 3^{rd} party successfully has authenticated the individual via the user device for enrolment with the access point.

In an embodiment, the enrolled biometric data is stored locally at the access point.

In an embodiment, the enrolled biometric data is encrypted.

In an embodiment, the individual is guided through the enrolment by instructions being provided via the user device.

In an embodiment, the access point enrolls the individual by deriving biometric data from any one of face, iris, fingerprint, palmprint or voice of the individual.

In an embodiment, the enrolled biometric data is sent in an encrypted form, or via a secure channel, to a trusted biometric server for storage, thereby allowing the individual to revoke the enrolled biometric template by sending an instruction to the trusted biometric server.

In an embodiment, the access point detects that the individual is in a physical vicinity of the access point for the trusted communication channel to be established.

In an embodiment, the access point requires the individual to perform authentication locally with the user device for the biometric data of the individual to be captured.

In an embodiment, after having captured the biometric data, the individual is requested to provide a confirmation via the user device that the enrolment can be completed.

In an embodiment, the access point captures further biometric data of the individual, compares the captured biometric data to the previously enrolled biometric data, and if there is a match authenticates the individual. This may be performed either locally at the access point or at the trusted biometric server (16).

In an embodiment, the access point establishes a secure channel with the user device.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates an embodiment where a user is being enrolled at an access point comprising a biometric data sensor in the form of a camera;

FIG. 2 shows a flowchart illustrating a method of the access point of enrolling biometric data of the user according to an embodiment;

FIG. 3 illustrates another embodiment where a user is being enrolled at an access point comprising a biometric data sensor in the form of a camera;

FIG. 4 illustrates a further embodiment where the access point communicates with a user device;

FIG. 5 illustrates a system where the enrolled biometric template is stored centrally at a trusted biometric server according to an embodiment;

FIG. 6 shows the user approaching the access point for authentication according to an embodiment; and

FIG. 7 illustrates an access point according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

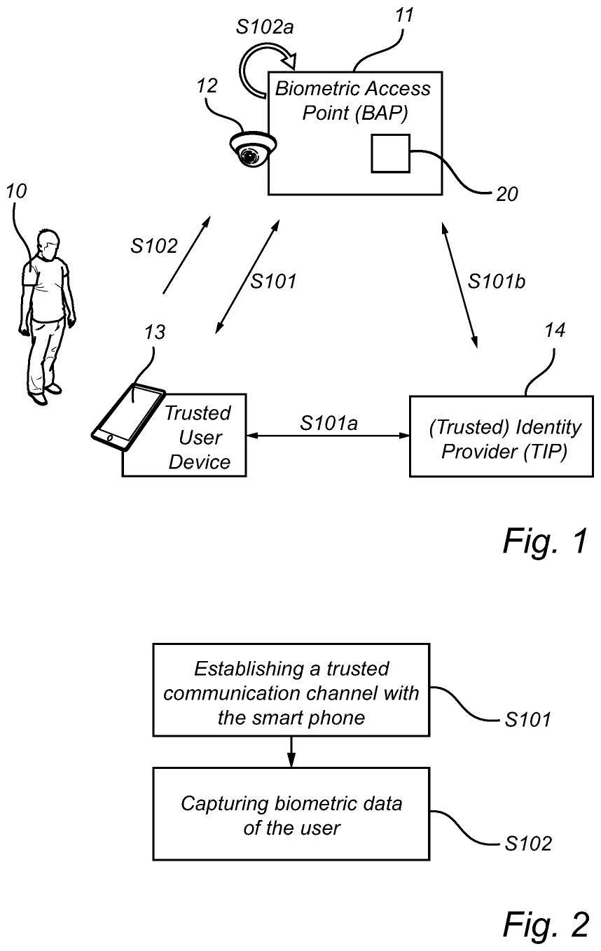

FIG. 1 illustrates an embodiment where a user 10 is being enrolled at an access point 11 comprising a biometric data sensor in the form of a camera 12 for recording biometric data of the user 10 by capturing an image of the user's face. The biometric data will subsequently be used for authenticating the user 10 at the access point 11. This is commonly referred to as face recognition.

Reference will further be made to FIG. 2 showing a flowchart illustrating a method of the access point 11 of enrolling biometric data of an individual (i.e. the user 10) according to an embodiment.

The access point 10 may form part of e.g. a building access control system where the user 10 only is allowed to enter a building upon being authenticated by the access point 11, or form part of a point-of-sale (POS) system where the user is allowed to make a purchase upon being authenticated. In a further example, the access point 11 is part of a vehicle such as a car, where the face of the user 11 must be recognized for the car to be started. In a further example, the access point is a personal computer (PC) or a laptop, for instance provided to the user by an employer. The access point 11 will in the following be referred to as a biometric access point (AP).

Now, upon the user 10 approaching the camera 12 of the BAP 11, the BAP 11 may detect that the user 10 is in physical vicinity of the BAP, for instance by the camera 12 registering that the user 10 is within a field of view of the camera 12 or that that a user device 13 of the user 10 is in the vicinity. The BAP 11 may even require that the user is within physical vicinity, such as e.g. on a maximum distance from the BAP 11, for enrolment and/or authentication to occur.

The user device 13 may be embodied in the form of a smart phone, a tablet, a smart watch, etc., and communication between the smart phone 13 and the BAP 11 may be performed via for instance Bluetooth, Ultra-Wideband, near-field communication, the Internet, etc.

Thus, the BAP 11 may sense that the smart phone 13 is dose, or register the coordinates of the smart phone using for example Global Positioning System (GPS) thereby concluding that the smart phone 13 is close. The user 10 may be notified via her smart phone 13 that the BAP 11 has discovered the user/smart phone, or the user may open an application (“app”) on the smart phone 13 and find the nearby BAP 11.

Alternatively, the user 10 is made aware that it is possible to enroll at the BAP 11, for instance by means of a physical signpost, or a Quick Response (QR) code or a near-field communication (NFC) tag being scanned with the smart phone 13, or by a location-aware app that automatically detects the BAP 11.

As previously mentioned, a user will typically not want to enroll her biometric data with a system she does not trust. Conversely, the system will not want to enroll a user that the system does not trust.

In embodiment, this is resolved by establishing a trusted communication channel between the BAP 11 (typically performed by a processing unit 20 configured with a communication interface) and the smart phone 13 in step S101, which trust is being ensured by a trusted 3^{rd} party 14 embodied for example by a certificate authority (CA) issuing a certificate to each of the BAP 11 and the smart phone 13. The trusted 3^{rd} party 14 will in the following be referred to as a trusted identity provider. In practice, the trusted identity provider may be an authority such as a national tax agency or a semi-official party such as a bank.

It is noted that the certificates may have been issued to the BAP 11 and the smart phone 13 by the trusted identity provider 14 long before the user 10 actually encounters the BAP 11, as illustrated by steps S101a and S101b.

Such certificate is commonly referred to as a digital certificate or a public key certificate and includes i.a. a public key being certified by the issuer, which allows the smart phone 13 to encrypt data for secure communication; information identifying the entity (i.e. the smart phone 13) that owns the public key and a digital signature of the public key created by the issuer of the certificate, which is used to verify authenticity of transmitted data in the sense that the BAP 11 is ensured that the data is sent from the smart phone 13.

Upon setting up a communication channel, the BAP 11 and the smart phone 13 will exchange messages in step S101 signed with the digital signatures included in the certificates, wherein the trust of the channel is ensured by the trusted identity provider 14 originally having issued the certificates being utilized to set up the trusted communication channel between the BAP 11 and the smart phone 13.

With the establishment of the trusted channel, the BAP 11 is allowed to enroll the biometric data of the user 10, which in this embodiment is performed by having the camera 12 capture an image of the user's face in step S102. The enrolled biometric data may further be encrypted for safe storage. Further, the biometric data may be stored locally at the access point 11 as illustrated with step S102a or at a central entity, as will be discussed in more detail hereinbelow. It may be envisaged that a secure communication channel are established between the BAP 11 and the smart phone 13 and/or the BAP 11 and the central entity (being e.g. a trusted identify provider or a trusted biometric server) using for instance Transport Layer Security (TLS).

In an embodiment, the user 10 may authenticate locally on the smart phone 13 using biometric authentication or a PIN code, where successful local authentication will allow the enrolment process to start.

The biometric data of the user 10 has thus been enrolled by the BAP 11 and may subsequently be used to authenticate the user 10.

Thus, when the user at some other occasion encounters the access point 11, the camera 12 will capture an image of the user's face and compare biometric data derived from the captured image with the enrolled biometric data, commonly referred to as template, and if the derived biometric data matches the enrolled template, the user 10 is authenticated and will be allowed to, e.g., enter the premises in a scenario where the BAP 11 is part of a building access control system.

As is understood, in order to perform the matching with the enrolled template, the BAP 11 may again set up a trusted channel with the smart phone 13 during the authentication process to acquire a user identifier to fetch the enrolled template associated with the particular user, since the BAP 11 may store hundreds or even thousands of enrolled templates. The BAP 11 may thus typically associate a user identifier with each enrolled template during the enrolment process, which also provides additional security not only considering the face of the user but also that the user identifier.

Advantageously, ubiquitous and seamless biometric enrollment and subsequent authentication—is provided by enabling trust between two parties with the help of a 3rd party at the time of enrollment; the two parties are both trusting the 3rd party before the enrollment commences.

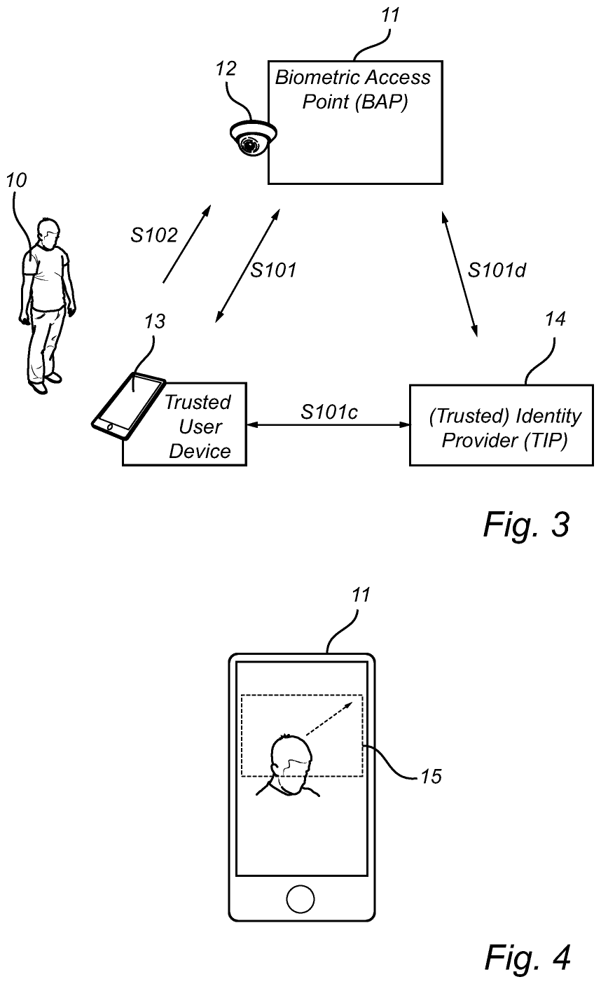

With reference to FIG. 3, in an alternative to the embodiment of FIG. 1, the user 10 may in step S101c via his smart phone 13 authenticate himself with the trusted identify provider 14 indicating that the authentication is to be undertaken for the BAP 11. This may be performed using for instance BankID (commonly used in Sweden) or some other appropriate electronic identification system.

Upon being successfully authenticated, the trusted identity provider 14 notifies the BAP 11 accordingly in step S101d, wherein a trusted communication channel is established between the BAP 11 and the smart phone 13 in step S101, the trust of which is being ensured by the trusted identity provider 14. Thereafter, the BAP 11 enrolls the biometric data of the user 10 in step S102

FIG. 4 illustrates a further embodiment where the BAP 11 communicates with the smart phone 13, possibly via the previously mentioned app executing on the smart phone 13, in order to guide the user 10 via which the BAP 11 is enabled to guide the user 10 through the enrolment and/or authentication by providing instructions via the smart phone 13. Thus, the processing unit 20 sends instructions over the communication interface to the smart phone 13 which guides the user 10 accordingly, for instance visually via the screen.

In this particular example, a guiding box 15 is displayed on the screen of the smart phone 13, in which the user's face is to be positioned for the image to be correctly captured by the camera 12. The BAP 11 thus indicates with an arrow on the screen that the user is to move slightly in front of the camera 12 for the face to be centred inside the box 15.

This is particularly advantageous since the BAP, being for instance a POS terminal, typically will not comprise a graphical user interface (GUI), such as a display or screen, on which feedback or instructions can be provided to the user 10 during enrolment or authentication.

In a further embodiment, when the capturing of the biometric data is complete, the BAP 11 may inform the user 10 accordingly via the screen of the smart phone 13, in response to which the user 10 may provide a confirmation, typically in the form of fingerprint authentication or by entering a personal identification number (PIN) code on the smart phone 13. The enrolment is thus completed and the BAP 11 will store the enrolled biometric data derived from the captured image either locally at the BAP 11 or at a central entity.

For instance, assuming that the BPA n is part of a home access control system of the user 10 for entering the house and/or turning off the alarm, where the user only will enroll her biometric template at one or a couple of BAPs such as one mounted at a front entrance and another one at a back entrance, the template could typically be stored locally at each BAP. If the user wishes to revoke her enrolled biometric template, she may do so at each BAP with undue burden.

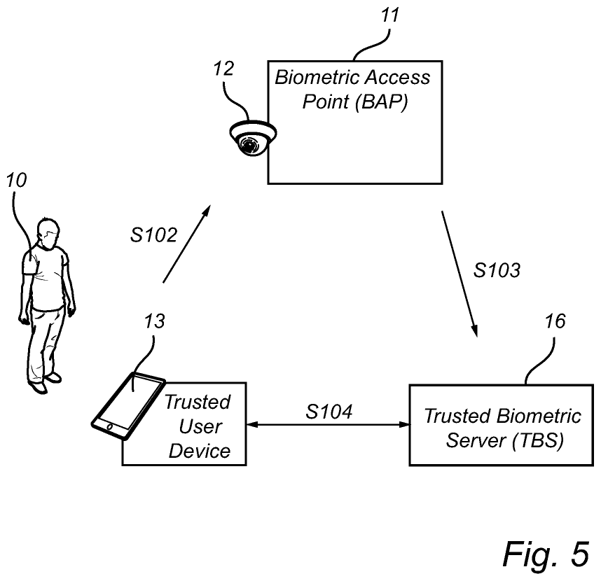

FIG. 5 illustrates a system where the enrolled biometric template is stored centrally at a trusted biometric server 16 according to an embodiment.

Assuming that the BPA 11 is part of an access control system of a work place of the user 10 having multiple entrances, and where the user possibly may have to undergo authentication at various locations when on the premises, for instance to reach an archive or a server hall.

In another example, the BAP 11 may be embodied by a POS terminal of a multinational store chain potentially hosting hundreds of POS terminals.

In such scenarios, the user 10 would typically only want to enroll his biometric template at one of the BAPs 11. After the enrollment is performed at the BAP 11 in step S102 as has been described hereinabove, the BAP 11 would in an embodiment send the enrolled biometric template—typically in encrypted form—to the trusted biometric server 16 in step S103 for secure communication and subsequent storage. In case the enrolled biometric template is encrypted, the trusted biometric server 16 will typically have access to a corresponding decryption key. As is understood, the smart phone 13 may also be included in this public key infrastructure (PKI) scheme for securely transferring encrypted data to, and receiving encrypted data from, the BAP 11 and/or trusted server 16

An advantage with central storage of the (encrypted) enrolled biometric template is that it enables for the user 10 to send a message to the trusted biometric server 16 in step S104, for instance using a dedicated app, that the user 10 no longer wishes to store his biometric data with the system, in which case the trusted server 16 will revoke the enrolled template. It is noted that the message alternatively may be sent to the trusted biometric server 16 via any BAP comprised in the system. Thus, even though the user 10 registers with a system potentially comprising hundreds of BAPs, he is still in control of his enrolled biometric template, and can revoke the template at any time with a message sent with a simple key-press on his phone 13 to the trusted server 16.

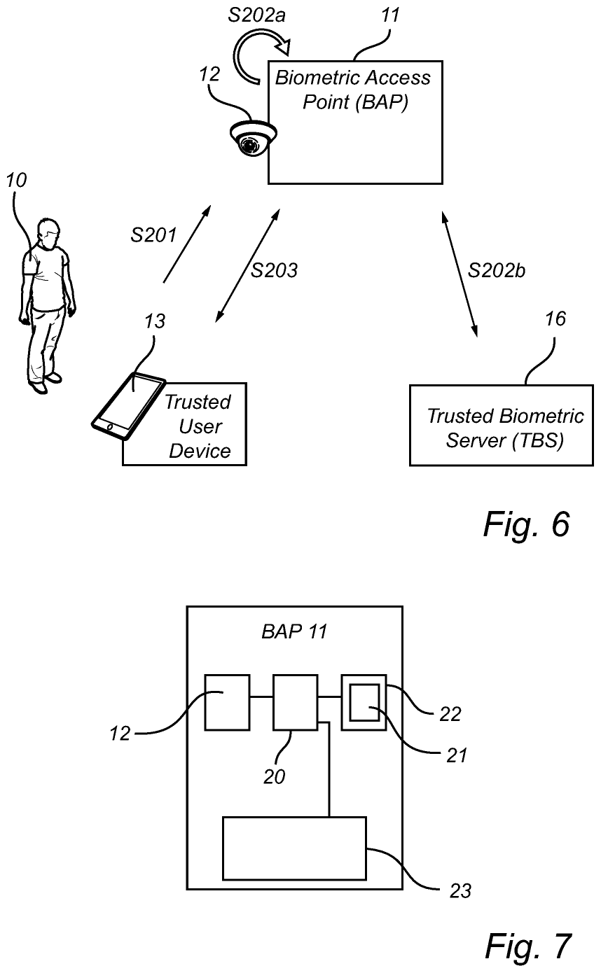

With reference to FIG. 6, upon the user 10 subsequently approaching the BAP 11 for authentication, the camera 12 will in step S201 acquire the biometric data of the user 10 in the form of an image of the user's face according to an embodiment.

The BAP 11 may either send the acquired biometric data to the trusted server 16 in step 202b, which will compare the acquired biometric data of the user 10 to the previously enrolled biometric template (typically associated with a user identifier), and if there is a match return an acknowledgement accordingly to the BAP 11, thereby authenticating the user 10 and taking appropriate action such as allowing the user 10 to enter the premises. Again, if the biometric authentication is performed at the trusted server 16 rather than at the BAP 11, the user 10 is more likely to trust the system.

Alternatively, the BAP 11 stores the enrolled biometric template locally, or requests the (encrypted) enrolled biometric template from the trusted server 16 in step S202b, and performs comparison locally in step S202a. If there is a match, the user 10 is authenticated in step S203. As is understood, the authentication may practically be embodied by a door opening, an alarm being turned off or a purchase being effected at a POS terminal, etc.

As is understood, the establishment of trust between the smart phone 13, the BAP 11 and the trusted identity provider 14 may be undertaken via the trusted biometric server 16, such that any communication between the smart phone 13 and the trusted identity provider 14 on the one hand and between the BAP 11 and the trusted identity provider 14 on the other will pass via the trusted biometric server 16 acting as a gateway to the trusted identity provider 14. In other words, the trusted biometric server 16 may be connected to the trusted identity provider 16 or even provide the service of the trusted identity provider 16 itself.

Further, in the exemplifying embodiments herein, the biometric data of the user 10 is derived from a captured image of the user's face. However, it is envisaged that the trusted server 16 may handle many different types of biometric data. For instance, one BAP may use face recognition, while another BAP may use fingerprint identification and a third BAP uses iris recognition, where all BAPs are connected to the trusted server which stores the enrolled templates and performs the biometric authentication.

FIG. 7 illustrates a BAP 11 according to an embodiment, where the steps of the method performed by the BAP 11 in practice are performed by a processing unit 20 embodied in the form of one or more microprocessors arranged to execute a computer program 21 downloaded to a storage medium 22 associated with the microprocessor, such as a Random Access Memory (RAM), a Flash memory or a hard disk drive. The processing unit 20 is arranged to cause the BAP 11 to carry out the method according to embodiments when the appropriate computer program 21 comprising computer-executable instructions is downloaded to the storage medium 22 and executed by the processing unit 20. The storage medium 22 may also be a computer program product comprising the computer program 21. Alternatively, the computer program 21 may be transferred to the storage medium 22 by means of a suitable computer program product, such as a Digital Versatile Disc (DVD) or a memory stick. As a further alternative, the computer program 21 may be downloaded to the storage medium 22 over a network. The processing unit 20 may alternatively be embodied in the form of a digital signal processor (DSP), an application specific integrated circuit (ASIC), a field-programmable gate array (FPGA), a complex programmable logic device (CPLD), etc. The BAP 11 further comprises a communication interface 23 (wired or wireless) over which the processing unit 20 is configured to transmit and receive data and a biometric data sensor 12 such as a camera, a fingerprint reader, an iris sensor, etc.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of an access point of enrolling biometric data of an individual, comprising:
establishing a trusted communication channel with a user device of the individual, the trust being ensured by a trusted 3rd party-;
capturing the biometric data of the individual, wherein the biometric data is enrolled with the access point; and
sending the enrolled biometric data in an encrypted form, or via a secure channel, to a trusted biometric server for storage, thereby allowing the individual to revoke the enrolled biometric template by sending instruction to the trusted biometric server.

2. The method of claim 1, the establishing of the trusted communication channel comprising:
exchanging messages comprising a digital signature of certificates issued by the trusted 3rd party to the access point and the user device of the individual.

3. The method of claim 1, the establishing of the trusted communication channel comprising:
acquiring a notification from the trusted 3rd party that the trusted 3rd party successfully has authenticated the individual via the user device for enrolment with the access point.

4. The method of claim 1, further comprising:
storing the enrolled biometric data.

5. The method of claim 1, further comprising:
encrypting the enrolled biometric data.

6. The method of claim 1, further comprising:
guiding the individual through the enrolment by providing instructions via the user device.

7. The method of claim 1, wherein the access point enrolls the individual by deriving biometric data from any one of face, iris, fingerprint, palmprint or voice of the individual.

8. The method of claim 1, further comprising:
detecting that the individual is in a physical vicinity of the access point for the trusted communication channel to be established.

9. The method of claim 1, further comprising:
requiring the individual to perform authentication locally with the user device for the biometric data of the individual to be captured.

10. The method of claim 1, further comprising:
requesting, after having captured the biometric data, the individual to provide a confirmation via the user device that the enrolment can be completed.

11. The method of claim 1, further comprising:
capturing further biometric data of the individual;
comparing the captured biometric data to the previously enrolled biometric data, and if there is a match:
authenticating the individual.

12. The method of claim 11, the comparing being performed locally at the access point or at the trusted biometric server.

13. The method of claim 1, further comprising;
associating a user identifier with each enrolled biometric data set.

14. The method of claim 1, further comprising;
establishing a secure channel with the user device.

15. (canceled)

16. A computer program product comprising a non-transitory computer readable medium, the computer readable medium having a computer program embodied thereon, the computer program comprising computer-executable instructions for causing an access point to perform the method of claim 1 when the computer-executable instructions are executed on a processing unit included in the access point.

17. An access point configured to enroll biometric data of an individual, comprising:
a processing unit configured to establish a trusted communication channel with a user device of the individual, the trust being ensured by a trusted 3rd party; and
a biometric data sensor configured to capture the biometric data of the individual, wherein the biometric data is enrolled with the access point, the processing unit further being configured to send the enrolled biometric data in an encrypted form, or via a secure channel, to a trusted biometric server for storage, thereby allowing the individual to revoke the enrolled biometric template by sending an instruction to the trusted biometric server.

18. The access point of claim 1, the processing unit further being configured to, when establishing the trusted communication channel:
cause exchange of messages comprising a digital signature of certificates issued by the trusted 3rd party to the access point and the user device of the individual.

19. The access point of claim 17, the processing unit further being configured to, when establishing the trusted communication channel:
acquire a notification from the trusted 3rd party that the trusted 3rd party successfully has authenticated the individual via the user device for enrolment with the access point.

20. The access point of claim 17 further comprising:
a memory configured to store the enrolled biometric data.

21. (canceled)

22. The access point of claim 17 the processing unit further being configured to:
guide the individual through the enrolment by providing instructions via the user device.

23-29. (canceled)
